(19) United States
(12) Patent Application Publication
(10) Pub. No.: US 2006/0113351 A1
(43) Pub. Date: Jun. 1, 2006

(54) Ultrasonic head

(75) Inventors: Yukio Ozaki, Kawasaki (JP); Toshinori Kasuga, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/105,437

(22) Filed: Apr. 14, 2005

(30) Foreign Application Priority Data
Nov. 30, 2004 (JP) JP2004-345951

(51) Int. Cl. B23K 20/12

(52) U.S. Cl. 228/2.1; 228/110.1

(57) ABSTRACT

An ultrasonic head 10a, which is used in an ultrasonic bonder for bonding an LSI chip and a substrate by using the ultrasonic vibration, includes: a protrusion 13a constituting a resonating apparatus 15 for contacting with the LSI chip and carrying out the ultrasonic vibration; a thermal conductive elastic body 17a placed on a surface of a main shaft 12 constituting the resonating apparatus 15; and a heater 16a which is placed on a surface of the thermal conductive elastic body 17a and produces a heat and gives the heat through the thermal conductive elastic body 17a and the main shaft 12 and protrusion 13a constituting the resonating apparatus 15 to a vicinity of a bonding portion between the LSI chip and the substrate.

### BACKGROUND OF THE INVENTION

The present invention relates to an ultrasonic head in an ultrasonic bonder for bonding a first target and a second target by using an ultrasonic vibration.

Up to now, an ultrasonic bonder for giving an ultrasonic vibration to an LSI chip to thereby bond the LSI chip to a substrate has been used. In the ultrasonic bonder, a bump placed on a lower surface of the LSI chip and a pad placed on an upper surface of the substrate are brought into contact, and an ultrasonic head is then used to give the ultrasonic vibration to the LSI chip. Accordingly, the bump and the pad are rubbed against each other, and their bonding surfaces are solid-phase-coupled.

Note that an under fill of resin or the like is typically formed in a vicinity of a bonding portion between the LSI chip and the substrate. When a thermosetting material is used as the under fill, the vicinity of the bonding portion between the LSI chip and the substrate is heated in forming the under fill. For this reason, at the time of the heating, in order to prevent a bonding break from being induced between the LSI chip and the substrate because of a difference between thermal expansibilities of the under fill, the LSI chip, and the substrate, the bonding portion needs to be heated at a temperature similar to a heating temperature in setting the under fill when the LSI chip and the substrate are bonded.

In this way, when the LSI chip and the substrate are bonded, as the prior art for heating the bonding portion, for example, there is a technology according to Patent document 1. In the technology according to Patent document 1, as shown in FIG. 7, a resonating apparatus 407 having an action plane 410 is supported by a supporter 408. Inside the supporter 408, a heater 416 is placed and configured so as to heat an opposite plate 415 and use its radiation heat, thereby heating the action plane 410 of the resonating apparatus 407. Thus, the bonding target, for example, the bonding portion between the LSI chip and the substrate is heated.

In this technology, the resonating apparatus 407 and the action plane 410 are heated by using the radiation heat. Thus, the technology has a merit that there is no limit on an installation position of the heater 416. However, a heat conduction efficiency through the radiation heat is poor.

On the other hand, as an example of another prior art, there is an ultrasonic head 300, as shown in a top view of FIG. 8(a) and a sectional view of FIG. 8(b) taken along a line X-X of FIG. 8(a). In this prior art, in a main shaft 302 which is coupled with an ultrasonic vibrator 311 and carries out an ultrasonic vibration, bar-shaped heaters 304 are inserted into holes 310 formed in the vicinities of protrusions 303a, 303b attached to the main shaft 302.

The heater 304 is originally configured so as to contact with the main shaft 302 to thereby transmit the heat. However, in the prior art, in order to reduce the induction of thermal stress, an outer diameter of the heater 304 needs to be configured so as to be smaller than an inner circumference diameter of the hole 310. For this reason, gap is formed between the heater 304 and the main shaft 302, which reduces the thermal efficiency.

Moreover, the heater 304 configured so as to contact with the main shaft 302 as mentioned above can be provided only at the position where a node of a standing wave is configured on the main shaft 302 of the ultrasonic head 300. This is because the heater 304 regulates the ultrasonic vibration. Thus, not only the protrusions 303a, 303b but also the bonding portion of the bonding target could not be always heated with a sufficient thermal efficiency.

[Patent document 1] JP 2003-282644 A

### SUMMARY OF THE INVENTION

In this way, the prior art in the case of using the radiation heat, although having the merit that the ultrasonic vibration is not regulated by the heater, has a problem in that the thermal efficiency is poor because the radiation heat is used to heat the bonding portion between the LSI chip and the substrate.

Also, the configuration of bringing the heater into contact with the resonator has a problem in that the installation position of the heater is limited to the position corresponding to the node of the standing wave, and further the gap is formed in order to reduce the induction of the thermal stress, leading to a reduction in the thermal efficiency.

The present invention is proposed to solve the conventional problems. Therefore, an object of the present invention is to provide an ultrasonic bonding technology for improving the thermal efficiency without regulating the ultrasonic vibration.

A resonating apparatus according to the present invention, which is used in an ultrasonic bonder bonding a first target and a second target by using an ultrasonic vibration, includes: a resonating unit contacting with at least the first target and carrying out an ultrasonic vibration; a thermal conductive elastic body placed on a surface of the resonating unit; and a heater body which is placed on a surface of the thermal conductive elastic body and produces a heat and gives the heat to a vicinity of a bonding portion between the first target and the second target through the thermal conductive elastic body and the resonating unit.

With this configuration, owing to a thermally conductive elastic body existing between the resonating unit and the heater body, the ultrasonic vibration of the resonating unit is not regulated by the heater body, thereby preventing the thermal efficiency from being reduced.

Also, in the resonating apparatus according to the present invention, the thermal conductive elastic body is filled on a predetermined surface of the resonating unit and constitutes a plate-shaped body, and the heater body is plate-shaped and placed on a surface opposite to a contact surface with the resonating unit in the thermal conductive elastic body.

Also, in the resonating apparatus according to the present invention, the thermal conductive elastic body is filled on an inner circumferential surface of a hole formed in the resonating unit and constitutes a cylinder, and the heater body is bar-shaped and placed inside the cylinder of the thermal conductive elastic body.

Also, in the resonating apparatus according to the present invention, the heater body or a radiation member into which the heater body is incorporated is shaped so as to cover the resonating unit.

Also, the resonating apparatus according to the present invention, which is used in an ultrasonic bonder bonding a first target and a second target by using an ultrasonic vibration, includes: a resonating unit for contacting with at least the first target and vibrating; and a heater body which is molded integrally with the resonating unit on a surface of the thermal conductive elastic body and produces a heat and gives the heat to a vicinity of a bonding portion between the first target and the second target through the thermal conductive elastic body and the resonating unit.

With this configuration, since the resonating unit and the heater body are integrally molded, the reduction in the thermal efficiency can be prevented without regulation of the ultrasonic vibration of the resonating unit caused by the heater body.

Also, the ultrasonic head according to the present invention has the configuration of coupling the ultrasonic vibrator to any of the resonating apparatuses. Moreover, the ultrasonic bonder according to the present invention, including the ultrasonic head and a pressing mechanism pressing the protrusion on the plane opposite to at least one of the first and second targets against at least one of the first and second objects, and is configured to give the ultrasonic vibration to the target.

The present invention, although having the heater body giving the heat to the vicinity of the bonding portion between the first target and the second target, in which the heater body does not regulate the ultrasonic vibration of the resonating unit, can prevent the thermal efficiency from being reduced when the heater body transmits the heat to the resonating unit.

### BRIEF DESCRIPTION OF THE DRAWINGS

FIG. 1 is a view showing a configuration of an ultrasonic bonder,

FIG. 2(a) is a perspective view showing a first configuration of the ultrasonic head,

FIG. 2(b) is a side view showing a first configuration of the ultrasonic head,

FIG. 2(c) is a sectional view showing a first configuration of the ultrasonic head,

FIG. 3 is a view showing a bonding portion between a semiconductor chip and a substrate,

FIG. 4(a) is a side view showing a second configuration of the ultrasonic head,

FIG. 4(b) is a sectional view showing a second configuration of the ultrasonic head,

FIG. 5(a) is a side view showing a third configuration of the ultrasonic head,

FIG. 5(b) is a sectional view showing a third configuration of the ultrasonic head,

FIG. 6(a) is a side view showing a fourth configuration of the ultrasonic head,

FIG. 6(b) is a sectional view showing a fourth configuration of the ultrasonic head,

FIG. 7 is a view showing an ultrasonic head having a heating mechanism through a conventional radiation heat,

FIG. 8(a) is a top view showing an ultrasonic head having a heating mechanism through contact with the conventional heater,

FIG. 8(b) is a sectional view showing the ultrasonic head having a heating mechanism through contact with the conventional heater.

### DETAILED DESCRIPTION OF THE INVENTION

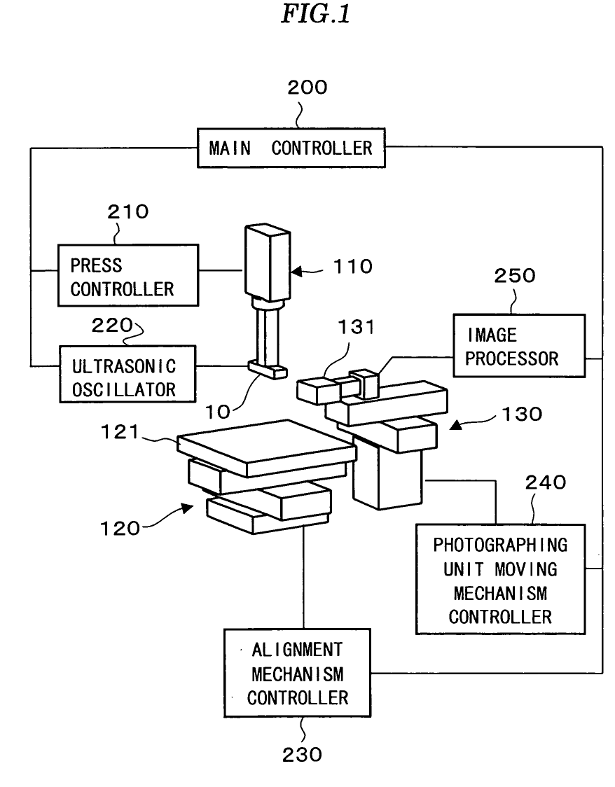

The ultrasonic bonder using the ultrasonic head in the embodiment of the present invention will be described below by using the drawings. FIG. 1 shows the configuration of the ultrasonic bonder.

In FIG. 1, the ultrasonic bonder has a pressing mechanism 110, an alignment mechanism 120, a stage 121, a photographing unit moving mechanism 130, and a photographing unit 131. An ultrasonic head 10 is mounted at a tip of the pressing mechanism 110. The pressing mechanism 110 (that corresponds to the pressing mechanism of the present invention) lifts up and down the ultrasonic head 10 in a vertical direction (a Z-axis direction). An adsorbing mechanism (not shown) is installed in the ultrasonic head 10, and adsorbs an LSI chip as a first target. The pressing mechanism 110 presses the LSI chip, which is adsorbed in the ultrasonic head 10, against a substrate that is a second target held on the stage 121.

The stage 121 is fixed to an upper end of the alignment mechanism 120, and the alignment mechanism 120 moves the stage 121 inside a horizontal plane (X-Y plane) Accordingly, the stage 121 is moved without any variation in an inclination with respect to a Z-axis. The photographing unit 131 is fixed to the photographing unit moving mechanism 130 so that a predetermined region above the stage 121 becomes a photograph range. The photographing unit moving mechanism 130 moves the photographing unit 131 inside the horizontal plane (X-Y plane).

The ultrasonic bonder further has a press controller 210, an ultrasonic oscillator 220, a photographing unit moving mechanism controller 240, an image processor 250 and a main controller 200. Under the control of the main controller 200, the ultrasonic oscillator 220 outputs an ultrasonic drive signal of a predetermined frequency to the ultrasonic head 10.

A substrate to which a chip is bonded is set on the stage 121. The photographing unit moving mechanism controller 240 advances the photographing unit 131 between the ultrasonic head 10 and the stage 121 in a state where the ultrasonic head 10 and the stage 121 are separated. Then, the photographing unit 131 photographs the LSI chip adsorbed in the ultrasonic head 10 and the substrate set on the stage 121, and outputs a corresponding image signal. The image processor 250 performs a predetermined image process on the image signal from the photographing unit 131 and generates a state signal indicating an overlapping state in the Z-axis direction between the LSI chip and substrate which should be bonded.

An alignment mechanism controller 230 carries out a drive control (positioning) of the alignment mechanism 120 so that the LSI chip adsorbed in the ultrasonic head 10 and the substrate set on the state 121 have a predetermined position relation, in accordance with the state signal indicating the overlapping state, under the control of the main controller 200. When the positioning has been completed, the photographing unit moving mechanism controller 240 withdraws the photographing unit 131 to a predetermined wait position from between the ultrasonic head 10 and the stage 121. After the positioning, the press controller 210 carries out the drive control of the pressing mechanism 110 under the control of the main controller 200, so that the LSI chip adsorbed in the ultrasonic head 10 is brought into contact with the substrate, which is the bonding target, and the LSI chip is pressed against the substrate at a predetermined pressure.

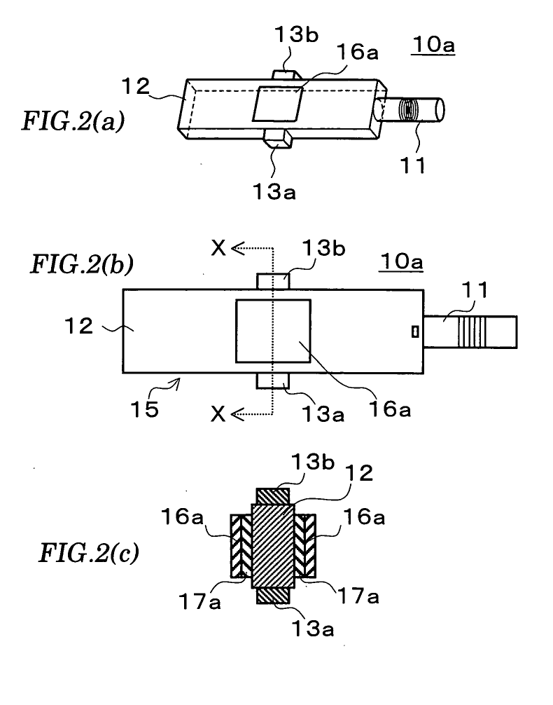

The detailed configuration of the ultrasonic head 10 will be described below. At first, a first configuration of the ultrasonic head 10 is explained. FIG. 2(a)-2(c) show the first configuration of the ultrasonic head 10. FIG. 2(a) is a perspective view, FIG. 2(b) is a side view, and FIG. 2(c) is a sectional view taken along a line X-X of FIG. 2(b).

In an ultrasonic head 10a shown in FIG. 2(a)-2(c), an ultrasonic vibrator 11 generates the ultrasonic vibration. Moreover, a main shaft 12 and protrusions 13a, 13b constitute a resonating apparatus 15 (which corresponds to the resonating unit of the present invention) of the ultrasonic vibration. The main shaft 12 is coupled to the ultrasonic vibrator 11 and extended in an advancement direction of the ultrasonic vibration generated from the ultrasonic vibrator 11. The protrusions 13a, 13b protrude from a center of a longitudinal direction of the main shaft 12 to a direction vertical to the longitudinal direction of the main shaft 12. Among them, the protrusion 13a includes an adsorbing mechanism for adsorbing and holding the LSI chip (for example, an opening for sucking air and generating a negative pressure). The ultrasonic head 10a is pressed against a substrate in a state where the LSI chip is adsorbed and held in the protrusion 13a. Then, the ultrasonic vibration (longitudinal wave) generated from the ultrasonic vibrator 11 is resonated in the resonating apparatus 15, and the ultrasonic vibration of the main shaft 12 that is at the resonated state is given from the protrusion 13a to the LSI chip that is the bonding target.

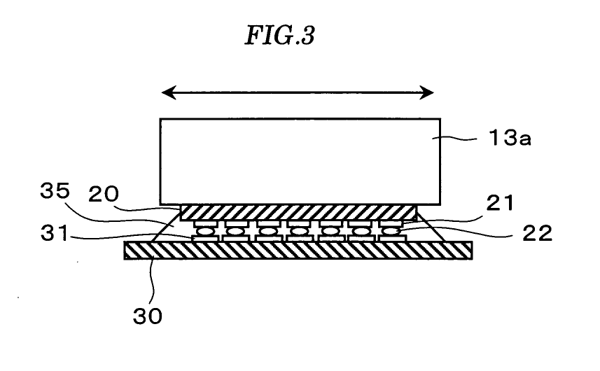

FIG. 3 is a view showing the bonding portion between the LSI chip and the substrate. In FIG. 3, a plurality of electrode terminals 21 are placed on a lower surface of an LSI chip 20. Moreover, a bump 22 is formed in each of the electrode terminals 21. On the other hand, a plurality of pads 31 are placed on an upper surface of a substrate 30 so as to be opposite to the bump 22. In the ultrasonic bonder, the positioning is carried out by the image processor 250 and the alignment mechanism controller 230 in such a way that the ultrasonic head 10a is pressed against a surface of the LSI chip 20 opposite to the surface on which the electrode terminals 21 are formed. In this state, when the ultrasonic head 10a is vibrated at an ultrasonic frequency (for example 40 kHz) in a direction (refer to an arrow shown in FIG. 3) parallel to the bonding portion to the LSI chip 20, the ultrasonic vibration causes the bump 22 and the pad 31 to be rubbed against each other, which causes their contact surfaces to be smoothed and integrated (solid-phase-coupled). Accordingly, each bump 22 of the LSI chip 20 is bonded to the pad 31 on the substrate 30, and the electric connection between the LSI chip 20 and the substrate 30 is surely attained. Then, with the bump 22 being bonded to the pad 31, an under fill 35 is filled between the LSI chip 20 and the substrate 30.

Referring again to FIG. 2(a)-2(c), the explanation is carried out. Thermal conductive elastic bodies 17a are plate-shaped and placed in the vicinities of the protrusions 13a, 13b in the respective two sides of the main shaft 12. The thermal conductive elastic bodies 17a are constituted by silicon gel in the form of sheet, paste, or the like, or silicon rubber in the form of sheet, paste, adhesive, potting agent, seal agent, or the like having a high thermal conductivity.

Two heaters 16a are plate-shaped. When the under fill 35 is heated for setting, in order to prevent the bonding break from being induced between the LSI chip 20 and the substrate 30 because of the difference between the thermal expansibilities of the under fill 35, the LSI chip 20 and the substrate 30, the heaters 16a heat in advance the bonding portion at a temperature similar to a heating temperature in setting the under fill 35, prior to bonding the LSI chip 20 and the substrate 30. The two heaters 16a are placed on the surface opposite to the contact surface with the main shaft 12 in the thermal conductive elastic body 17a.

That is, the thermal conductive elastic body 17a is configured so as to lie between the main shaft 12 and the heater 16a. Thus, even if the heater 16a cannot be moved being fixed by a different member and the like, the ultrasonic vibrations of the main shaft 12 and protrusion 13a are never regulated owing to the elastic force of the thermal conductive elastic body 17a. Moreover, the thermal conductivity of the thermal conductive elastic body 17a enables the heat from the heater 16a to be efficiently transmitted through the thermal conductive elastic body 17a, the main shaft 12 and the protrusion 13a to the bonding portion between the LSI chip 20 and the substrate 30.

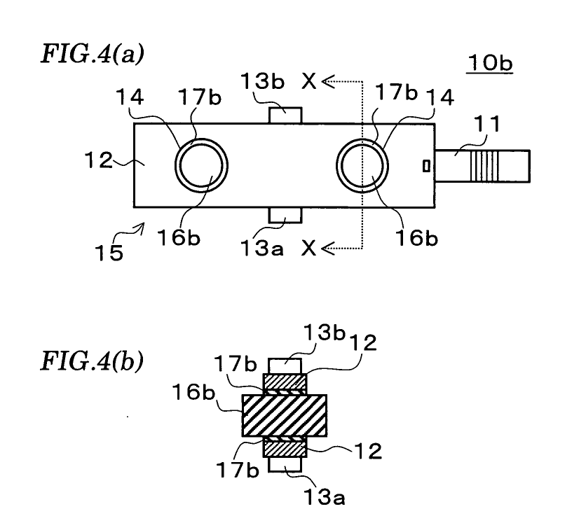

A second configuration of the ultrasonic head 10 will be described below. FIG. 4(a)-4(b) is a view showing the second configuration of the ultrasonic head 10. FIG. 4(a) is a side view, and FIG. 4(b) is a sectional view taken along a line X-X of FIG. 4(a).

In an ultrasonic head 10b shown in FIG. 4(a)-4(b), the ultrasonic vibrator 11, the main shaft 12, and the protrusions 13a, 13b are similar to the ultrasonic vibrator 11, main shaft 12, and protrusions 13a, 13b in the ultrasonic head 10a shown in FIG. 2. Thus, their explanations are omitted.

Note that two holes 14 are formed in the main shaft 12. Cylindrical thermal conductive elastic bodies 17b are filled on respective inner circumferential surfaces of the holes 14 and arranged cylindrically (which correspond to the cylindrical body of the present invention). The cylindrical thermal conductive elastic bodies 17b are made of, for example, silicon gel and silicon rubber. The heater 16b heats in advance the bonding portion at the temperature similar to the heating temperature when the under fill 35 is set, prior to bonding the LSI chip 20 and the substrate 30, similarly to the heater 16a in the ultrasonic head 10a shown in FIG. 2, and has the shape of a cylinder and is arranged at the respective portions inside the cylinder of the thermal conductive elastic body 17b.

That is, the thermal conductive elastic body. 17b is configured so as to lie between the main shaft 12 and the heater 16b. Thus, even if the heater 16b is fixed, the ultrasonic vibration in the main shaft 12 and protrusion 13a is not regulated, and further the heat from the heater 16b can be efficiently transmitted through the thermal conductive elastic body 17b, the main shaft 12 and the protrusion 13a to the bonding portion between the LSI chip 20 and the substrate 30.

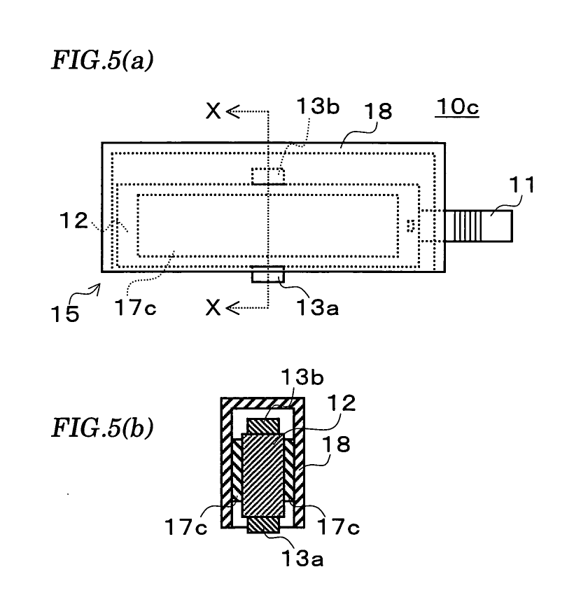

A third configuration of the ultrasonic head 10 will be described below. FIG. 5(a)-5(b) is a view showing the third configuration of the ultrasonic head 10. FIG. 5(a) is a side view, and FIG. 5(b) is a sectional view taken along a line X-X of FIG. 5(a).

In an ultrasonic head 10c shown in FIG. 5, the ultrasonic vibrator 11, the main shaft 12, and the protrusions 13a, 13b are similar to the ultrasonic vibrator 11, main shaft 12, and protrusions 13a, 13b in the ultrasonic head 10a shown in FIG. 2. Thus, their explanations are omitted.

Thermal conductive elastic bodies 17c are filled on each of two sides of the main shaft 12. The thermal conductive elastic bodies 17c are made of silicon gel or silicon rubber. A radiation member 18 is U-shaped, and a heater (not shown) is incorporated thereinto. The radiation member 18 is placed so as to cover the main shaft 12, and an inner wall surface of the radiation member 18 is in contact with a surface opposite to a contact surface with the main shaft 12 in the thermal conductive elastic body 17c.

That is, the thermal conductive elastic body 17c is configured so as to lie between the main shaft 12 and the radiation member 18 into which the heater is incorporated. Thus, even if the radiation member 18 is fixed, the ultrasonic vibration in the main shaft 12 and protrusion 13a is not regulated, and further the heat from the heater inside the radiation member 18 can be efficiently transmitted through the thermal conductive elastic body 17c, the main shaft 12, and the protrusion 13a to the bonding portion between the LSI chip 20 and the substrate 30. It is noted that a heater which has the shape similar to the radiation member 18 and is similarly placed may be used instead of the radiation member 18.

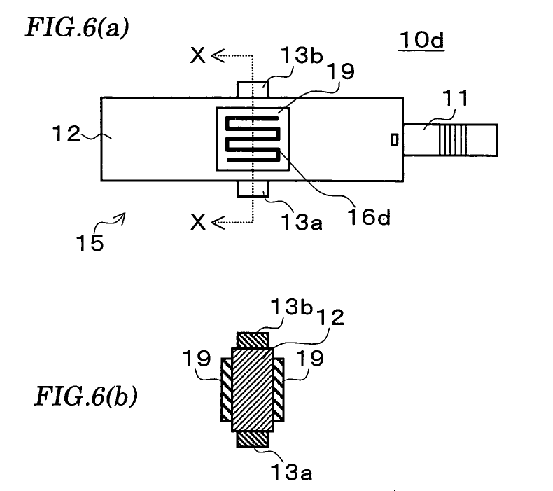

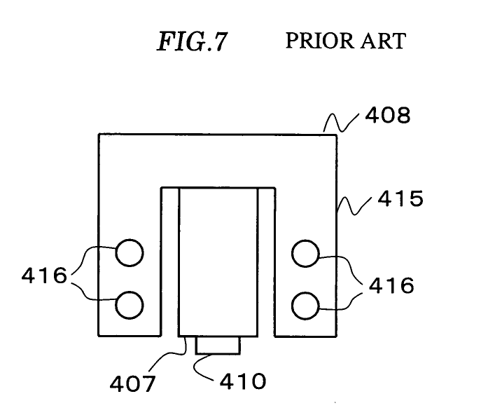

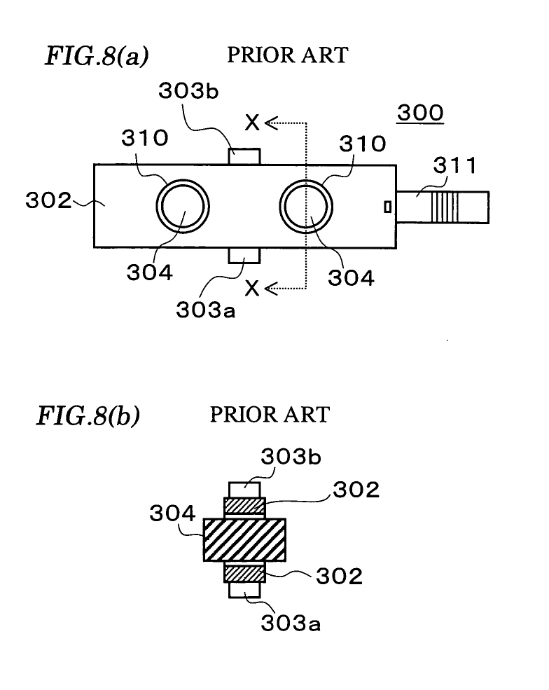

A fourth configuration of the ultrasonic head 10d will be described below. FIG. 6(a)-6(b) is a view showing the fourth configuration of the ultrasonic head 10d. FIG. 6(a) is a side view, and FIG. 6(b) is a sectional view taken along a line X-X of FIG. 6(a).

In an ultrasonic head 10d shown in FIG. 6(a)-6(b), the ultrasonic vibrator 11, the main shaft 12, and the protrusions 13a, 13b are similar to the ultrasonic vibrator 11, main shaft 12, and protrusions 13a, 13b in the ultrasonic head 10a shown in FIG. 2. Thus, their explanations are omitted.

A heater 19 in which a heater pattern 16d is formed is placed on each of two sides of the main shaft 12. The heaters 19 are molded integrally with the main shaft 12, and together with the main shaft 12 constitute the resonating apparatus for carrying out the ultrasonic vibration.

Thus, the ultrasonic vibration in the main shaft 12 and protrusion 13a is never regulated by the heater 19, and further the heat from the heater pattern 16d in the heater 19 can be efficiently transmitted through the main shaft 12 and the protrusion 13a to the bonding portion between the LSI chip 20 and the substrate 30.

Note that in the above-mentioned embodiments, the case in which the ultrasonic bonder bonds the semiconductor chip and the substrate has been explained. However, the present invention can be applied to the case of bonding other two targets.

### INDUSTRIAL APPLICABILITY

As mentioned above, the ultrasonic head according to the present invention has the effect that enables the improvement of the thermal efficiency without regulation of the ultrasonic vibration, and is useful as the ultrasonic head.

What is claimed is:

1. A resonating apparatus in an ultrasonic bonder bonding a first target and a second target by using an ultrasonic vibration, comprising:
a resonating unit contacting with at least the first target and carrying out an ultrasonic vibration;
a thermal conductive elastic body placed on a surface of the resonating unit; and
a heater body which is placed on a surface of the thermal conductive elastic body and produces a heat and gives the heat to a vicinity of a bonding portion between the first target and the second target through the thermal conductive elastic body and the resonating unit.

2. The resonating apparatus according to claim 1, wherein the thermal conductive elastic body is filled on a predetermined surface of the resonating unit and constitutes a plate-shaped body, and
the heater body is plate-shaped and placed on a surface opposite to a contact surface with the resonating unit in the thermal conductive elastic body.

3. The resonating apparatus according to claim 1, wherein the thermal conductive elastic body is filled on an inner circumferential surface of a hole formed in the resonating unit and constitutes a cylinder, and
the heater body is bar-shaped and placed inside the cylinder of the thermal conductive elastic body.

4. The resonating apparatus according to claim 1, wherein the heater body or a radiation member into which the heater body is incorporated is shaped so as to cover the resonating unit.

5. A resonating apparatus in an ultrasonic bonder bonding a first target and a second target by using an ultrasonic vibration, comprising:
a resonating unit contacting with at least the first target and vibrating; and
a heater body which is molded integrally with the resonating unit on a surface of the resonating unit and produces a heat and gives the heat to a vicinity of a bonding portion between the first target and the second target through the thermal conductive elastic body and the resonating unit.

6. The resonating apparatus according to claim 1, wherein the thermal conductive elastic body is silicon gel or silicon rubber.

7. An ultrasonic head in an ultrasonic bonder bonding a first target and a second target by using an ultrasonic vibration, comprising:
an ultrasonic vibrator;
a resonating unit contacting with the first target and carrying out an ultrasonic vibration, and connected to the ultrasonic vibrator;
a thermal conductive elastic body placed on a surface of the resonating unit; and
a heater body which is placed on a surface of the thermal conductive elastic body and produces a heat and gives the heat to a vicinity of a bonding portion between the first target and the second target through the thermal conductive elastic body and the resonating unit.

8. The ultrasonic head according to claim 7, wherein the thermal conductive elastic body is plate-shaped and placed on a predetermined surface of the resonating unit, and
the heater body is plate-shaped and placed on a surface opposite to a contact surface with the resonating unit in the thermal conductive elastic body.

9. The ultrasonic head according to claim 7, wherein the thermal conductive elastic body is placed on an inner circumferential surface of a hole formed in the resonating unit and has a cylindrical shape, and
the heater body is bar-shaped and placed inside the cylinder of the thermal conductive elastic body.

10. The ultrasonic head according to claim 7, wherein the heater body or a radiation member into which the heater body is incorporated is shaped so as to cover the resonating unit.

11. An ultrasonic head in an ultrasonic bonder bonding a first target and a second target by using an ultrasonic vibration, comprising:
an ultrasonic vibrator;
a resonating unit contacting with the first target and vibrating, and connected to the ultrasonic vibrator; and
a heater body which is molded integrally with the resonating unit on a surface of the resonating unit and produces a heat and gives the heat to a vicinity of a bonding portion between the first target and the second target through the thermal conductive elastic body and the resonating unit.

12. The ultrasonic head according to claim 7, wherein the thermal conductive elastic body is silicon gel or silicon rubber.

13. An ultrasonic bonder bonding a first target and a second target by using an ultrasonic vibration, comprising:
a ultrasonic vibrator;
a resonating unit contacting with at least one of the first target and the second target and carrying out an ultrasonic vibration, and connected to the ultrasonic vibrator;
a thermal conductive elastic body placed on a surface of the resonating unit;
a heater body which is placed on a surface of the thermal conductive elastic body and produces a heat and gives the heat to a vicinity of a bonding portion between the first target and the second target through the thermal conductive elastic body and the resonating unit; and
a pressing mechanism in which the resonating unit presses a protrusion of a surface opposite to at least one of the first target and the second target to at least one of the first target and the second target.

14. The resonating apparatus according to claim 13, wherein the thermal conductive elastic body is plate-shaped and placed on a predetermined surface of the resonating unit, and
the heater body is plate-shaped and placed on a surface opposite to a contact surface with the resonating unit in the thermal conductive elastic body.

15. The resonating apparatus according to claim 13, wherein the thermal conductive elastic body is placed on an inner circumferential surface of a hole formed in the resonating unit and has a cylindrical shape, and
the heater body is bar-shaped and placed inside the cylinder of the thermal conductive elastic body.

16. The resonating apparatus according to claim 13, wherein the heater body or a radiation member into which the heater body is incorporated is shaped so as to cover the resonating unit.

17. An ultrasonic bonder bonding a first target and a second target by using an ultrasonic vibration, comprising:
an ultrasonic vibrator;
a resonating unit contacting with at least the first target and vibrating, and connected to the ultrasonic vibrator;
a heater body which is molded integrally with the resonating unit on a surface of the thermal conductive elastic body and produces a heat and gives the heat to a vicinity of a bonding portion between the first target and the second target through the thermal conductive elastic body and the resonating unit; and
a pressing mechanism in which the resonating unit presses a protrusion of a surface opposite to at least one of the first target and the second target to at least one of the first target and the second target.

18. The ultrasonic bonder according to claim 13, wherein the thermal conductive elastic body is silicon gel or silicon rubber.
